(19) United States
(12) Patent Application Publication
(10) Pub. No.: US 2025/0238752 A1
(43) Pub. Date: Jul. 24, 2025

(54) MONITORING SYSTEM

(71) Applicant: OVERWATCH IP PTY LTD, Ulverstone (AU)

(72) Inventors: Scott Cordwell, Ulverstone (AU); Simon Archdale, Ulverstone (TS); Mark Harris, Ulverstone (AU)

(21) Appl. No.: 19/177,181

(22) Filed: Apr. 11, 2025

Related U.S. Application Data
(63) Continuation of application No. PCT/AU2023/051004, filed on Oct. 11, 2023.

(30) Foreign Application Priority Data
Oct. 12, 2022 (AU) 2022902997

(51) Int. Cl. G06Q 10/0833; G06Q 10/0832

(52) U.S. Cl. CPC G06Q 10/0833; G06Q 10/0832

(57) ABSTRACT

This disclosure relates to a monitoring system and method for monitoring a jet engine in transit. The system includes a processor, transceiver, sensor and digital storage media for measuring environmental variables with respect to thresholds. A sensor probe is also disclosed for monitoring the status of a jet engine enclosed in sheeting.

### CROSS REFERENCE

This application is a bypass continuation of PCT/AU2023/051004, filed Oct. 11, 2023, and through that application claims the benefit of Australian Patent Application No. 2022902997, filed Oct. 12, 2022, the entireties of each of which are hereby incorporated by reference.

### FIELD OF THE INVENTION

The present invention relates to a monitoring system and in particular to a monitoring system for monitoring the status of a jet engine in transit.

The invention has been developed primarily for use in/with monitoring of jet engines in transit and will be described hereinafter with reference to this application. However, it will be appreciated that the invention is not limited to this particular field of use and could be used for monitoring the status of another object in transit.

### BACKGROUND OF THE INVENTION

At present, when substantial faults are found in jet engines, these may be removed from the aircraft that they are installed on, and sent to the manufacturer for remediation. It is desirable to monitor the position and status of such jet engines in transit back to the manufacturer, as well as in transit back to the aircraft that they were removed from.

When jet engines are being prepared for transit, they are mounted on a support base. The jet engine is preferably enclosed in heat shrink plastic before or after being mounted on the support base. The heat shrink plastic is intended to ensure that environmental conditions around the jet engine remain relatively constant.

Any discussion of the background art throughout the specification should in no way be considered as an admission that such background art is prior art, nor that such background art is widely known or forms part of the common general knowledge in the field in Australia or any other country.

### SUMMARY OF THE INVENTION

The invention seeks to provide a monitoring system which will overcome or substantially ameliorate at least some of the deficiencies of the prior art, or to at least provide an alternative.

According to a first aspect, the present invention comprises a monitoring system for monitoring a jet engine in transit, the monitoring system including:
a. a processor operatively configured for executing digital instructions;
b. at least one or more wireless transceivers;
c. at least one or more selected from
   i. a geo-positioning receiver configured for receiving geo-positioning signals from geo-positioning satellites, and
   ii. an altimeter;
d. digital storage media operatively connected to the processor and configured for storing data and instructions, the instructions being configured for directing the processor to carry out the steps of:
   i. receiving at least one or more selected from
      1. geo-positioning signals from a geo-positioning satellite,
      2. pressure signals from an altimeter;
   ii. determining one or more selected from
      1. the speed of the monitoring system, and
      2. the altitude of the monitoring system;
   iii. determining whether one or more selected from
      1. the speed of the monitoring system exceeds a predetermined threshold; and
      2. the altitude of the monitoring system exceeds a predetermined threshold; and
   iv. transmitting a status signal if one or more selected from the determined speed and the determined altitude of the monitoring system is below the predetermined threshold.

In one embodiment, the instructions may be configured for directing the processor to carry out the step of:
a. in the event that one or more selected from the determined speed and the determined altitude of the monitoring system is above the respective predetermined threshold, preventing the transmission of signals from the at least one or more wireless transceivers.

In one embodiment, the instructions may be configured for directing the processor to carry out the step of:
a. in the event that one or more selected from the determined speed and the determined altitude of the monitoring system is above the respective predetermined threshold, storing one or more selected from the determined speed and the determined altitude, together with a time stamp.

In one embodiment, the instructions may be configured for directing the processor to carry out the step of:
a. in the event that one or more selected from the determined speed and the determined altitude of the monitoring system is above the respective predetermined threshold, storing one or more selected from the determined speed and the determined altitude, together with the location of the monitoring system and a time stamp.

In one embodiment, the status signal includes the speed of the monitoring system.

In one embodiment, the status signal includes unique identifier for the monitoring system.

In one embodiment, the monitoring system includes at least one or more sensors.

In one embodiment, the at least one or more sensors include one or more selected from:
a. a temperature sensor;
b. a humidity sensor;
c. an accelerometer; and
d. any other suitable sensor.

In one embodiment, the instructions may be configured for directing the processor to carry out the step of:
a. receiving sensor signals from the at least one or more sensors.

In one embodiment, the instructions may be configured for directing the processor to carry out the step of:
a. receiving sensor signals from the at least one or more sensors at regular time intervals.

In one embodiment, the instructions may be configured for directing the processor to carry out the step of:
a. storing the received geo-positioning signals as monitoring events, together with a time stamp.

In one embodiment, the instructions may be configured for directing the processor to carry out the step of:
a. storing the received sensor signals as monitoring events, together with a time stamp.

In one embodiment, the status signal includes the sensor signals.

In one embodiment, the instructions may be configured for directing the processor to carry out the step of:
a. in the event that one or more selected from the determined speed and the determined altitude is above a predetermined threshold, storing the received sensor signals as monitoring events, together with a time stamp;
b. monitoring the determined speed and transmitting the stored monitoring events once the determined speed drops below the predetermined threshold.

In one embodiment, the processor and digital storage media together comprise a controller.

In one embodiment, the controller is housed within a control box.

In one embodiment, the control box includes a mounting arrangement configured for mounting the control box to a support base for the jet engine.

In one embodiment, the mounting arrangement includes one or more ratchet straps.

In one embodiment, the mounting arrangement includes a pair of ratchet straps attached to opposed ends of the control box.

In one embodiment, the instructions may be configured for directing the processor to carry out the step of:
a. receiving an acceleration signal from an accelerometer.

In one embodiment, the instructions may be configured for directing the processor to carry out the step of:
a. determining whether the acceleration signal exceeds a predetermined threshold.

In one embodiment, the instructions may be configured for directing the processor to carry out the step of:
a. in the event of the acceleration signal exceeding a predetermined threshold, retrieving a geo-positioning signal from the geo-positioning sensor.

In one embodiment, the instructions may be configured for directing the processor to carry out the step of:
a. storing the acceleration signal together with a timestamp and/or geo-positioning signal.

In one embodiment, the monitoring system includes a control box.

In one embodiment, the control box is configured for being securely attached to a base support for the jet engine.

In one embodiment, the monitoring system includes a sensor probe.

In one embodiment, the sensor probe is configured for being extended into an enclosure in which the jet engine is kept.

In one embodiment, the sensor probe as a sensor probe as described below.

According to a further aspect, the present invention comprises a method of monitoring the status of a jet engine in transit, the method being carried out on an electronic device and comprising the steps of:
a. receiving at least one or more selected from
   i. geo-positioning signals from a geo-positioning satellite,
   ii. pressure signals from an altimeter;
b. determining one or more selected from
   i. the speed of the monitoring system, and
   ii. the altitude of the monitoring system;
c. determining whether one or more selected from
   i. the speed of the monitoring system exceeds a predetermined threshold; and
   ii. the altitude of the monitoring system exceeds a predetermined threshold; and
d. transmitting a status signal if one or more selected from the determined speed and the determined altitude of the monitoring system is below the predetermined threshold.

In one embodiment, the method comprises the step of:
a. in the event that one or more selected from the determined speed and the determined altitude of the monitoring system is above the respective predetermined threshold, preventing the transmission of signals from the at least one or more wireless transceivers.

In one embodiment, the method comprises the step of:
a. in the event that one or more selected from the determined speed and the determined altitude of the monitoring system is above the respective predetermined threshold, storing one or more selected from the determined speed and the determined altitude, together with a time stamp.

In one embodiment, the method comprises the step of:
a. in the event that one or more selected from the determined speed and the determined altitude of the monitoring system is above the respective predetermined threshold, storing one or more selected from the determined speed and the determined altitude, together with the location of the monitoring system and a time stamp.

In one embodiment, the method comprises the step of:
a. receiving sensor signals from the at least one or more sensors.

In one embodiment, the method comprises the step of:
a. receiving sensor signals from the at least one or more sensors at regular time intervals.

In one embodiment, the method comprises the step of:
a. storing the received geo-positioning signals as monitoring events, together with a time stamp.

In one embodiment, the method comprises the step of:
a. storing the received sensor signals as monitoring events, together with a time stamp.

In one embodiment, the method comprises the step of:
a. in the event that one or more selected from the determined speed and the determined altitude is above a predetermined threshold, storing the received sensor signals as monitoring events, together with a time stamp;
b. monitoring the determined speed and transmitting the stored monitoring events once the determined speed drops below the predetermined threshold.

In one embodiment, the method comprises the step of:
a. receiving an acceleration signal from an accelerometer.

In one embodiment, the method comprises the step of:
a. determining whether the acceleration signal exceeds a predetermined threshold.

In one embodiment, the method comprises the step of:
a. in the event of the acceleration signal exceeding a predetermined threshold, retrieving a GPS signal from the geo-positioning sensor.

In one embodiment, the method comprises the step of:
a. storing the acceleration signal together with a timestamp and/or GPS signal.
b.

According to a further aspect, the present invention comprises a sensor probe for monitoring the status of a jet engine enclosed in sheeting; the sensor probe including:
a. a sensor probe formation configured for being inserted into an aperture in the sheeting;
b. an inner abutment formation configured for abutting an inner surface of the sheeting;
c. an outer abutment formation configured for abutting an outer surface of the sheeting;
d. a locking arrangement configured for closing the distance between the inner abutment formation and the outer abutment formation to thereby hold the sheeting between them.

In one embodiment, the inner abutment formation is dimensioned to be larger than the aperture.

In one embodiment, the outer abutment formation is dimensioned to be larger than the aperture.

In one embodiment, the locking arrangement includes threaded formations on an outer surface of the sensor probe formation.

In one embodiment, the locking arrangement comprises complementary threaded formations on a locking nut.

In one embodiment, the sensor probe formation is substantially cylindrical.

In one embodiment the sensor probe formation includes at least one or more sensors.

In one embodiment, the sensors include at least one or more sensors from the following list of sensors:
a. a temperature sensor;
b. humidity sensor;
c. an accelerometer; and
d. any other suitable sensor.

In one embodiment, the sensor probe includes a connector for connecting the at least one or more sensors to a controller.

In one embodiment, the sensor probe includes a controller.

In one embodiment, the sensors are configured for transmitting sensor signals to the controller.

In one embodiment, the controller includes:
a. a processor operatively connected to digital storage media, the digital storage media being configured for storing data and/or instructions for directing the processor.

In one embodiment, the controller is configured for
a. transmitting the sensor signals to a remote location.

In one embodiment, the controller is configured for
a. receiving at least one or more geo-positioning signals from a geo-positioning satellite;
b. determining one or more selected from
c. the speed of the monitoring system, and
d. the altitude of the monitoring system;
e. determining whether one or more selected from the speed of the monitoring system and the altitude of the monitoring system exceeds a predetermined threshold; and
f. transmitting a status signal if one or more selected from the determined speed and the determined altitude of the monitoring system is below the predetermined threshold.

In one embodiment, the inner abutment formation includes a slot formation for and inner abutment formation to be threaded through the aperture in the sheeting.

In one embodiment, the controller is housed within a control box.

In one embodiment, the control box includes a mounting arrangement configured for mounting the control box to a support base for the jet engine.

In one embodiment, the mounting arrangement includes one or more ratchet straps.

In one embodiment, the mounting arrangement includes a pair of ratchet straps attached to opposed ends of the control box.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 shows a network of computing devices on which a monitoring system described herein may be implemented;

FIG. 2 shows a schematic view of a monitoring system;

FIG. 3 shows a perspective view of a monitoring system installed in place on a base support for a jet engine in transit;

FIG. 4 shows a perspective view of a monitoring system;

FIGS. 5 shows a bottom view of a housing of a monitoring system;

FIG. 6 shows a close-up perspective view of a sensor probe;

FIG. 7 shows a exploded assembly view of the sensor probe of FIG. 6:

FIG. 8 shows a close-up view of a plastic enclosure surrounding a jet engine, the aperture being surrounded by a sticker;

FIG. 9 shows a sensor probe being inserted into the aperture of FIG. 8;

FIG. 10 shows an inner abutment formation being inserted through the aperture of FIG. 8;

FIG. 11 shows the inner abutment formation being pulled against an inner surface of the plastic enclosure of FIG. 8;

FIG. 12 shows an outer abutment formation being placed in abutment with the inner abutment formation of FIG. 11 to hold the plastic sheeting between the inner abutment formation and the outer abutment formation;

FIG. 13 shows a sensor probe with a lock nut turned on to outer threaded formations on the sensor body; and

FIGS. 14-16 show flowcharts illustrating methodologies carried out by the monitoring system.

FIG. 17 shows a sensor probe with a further outer threaded formation.

### DESCRIPTION OF EMBODIMENTS

It should be noted in the following description that like or the same reference numerals in different embodiments denote the same or similar features.

### System of Computing Devices

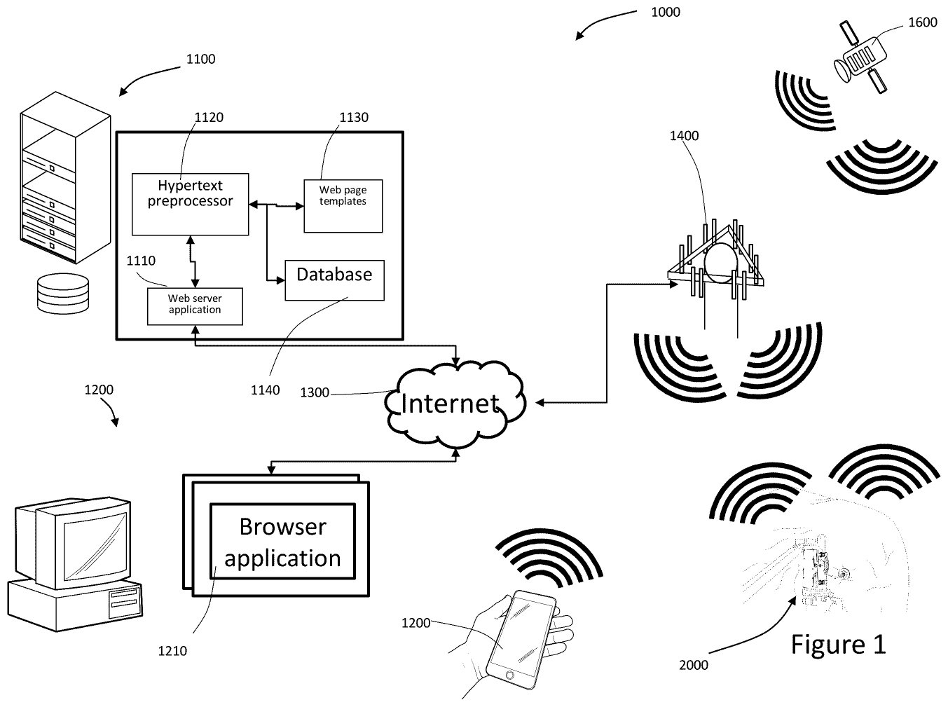

FIG. 1 shows a system 1000 of computing devices adapted for use together with a monitoring system 2000, and on which the methods described below may be carried out.

As such, the system 1000 includes a server 1100 for serving web pages to one or more client computing devices 1200 over the Internet 1300.

In a preferred embodiment, the server 1100 is a web server having a web server application 1110 for receiving requests, such as Hypertext Transfer Protocol (HTTP), HTTPS and File Transfer Protocol (FTP) or other requests under the TCP/IP standards stack, and serving hypertext web pages or files in response. The web server application 1110 may be, for example the Apache™ or the Microsoft™ IIS HTTP server.

The server 1100 is also provided with a hypertext preprocessor 1120 for processing one or more web page templates 1130 and data from one or more databases 1140 to generate hypertext web pages. The hypertext preprocessor may, for example, be the PHP: Hypertext Preprocessor (PHP) or Microsoft Asp™ hypertext preprocessor. The web server 1100 is also provided with web page templates 1130, such as one or more PHP or ASP files.

Upon receiving a request from the web server application 1110, the hypertext preprocessor 1120 is operable to retrieve a web page template from the web page templates 1130, execute any dynamic content therein, including updating or loading information from the one or more databases 1140, to compose a hypertext web page. The composed hypertext web page may comprise client-side code, such as Javascript, for Document Object Model (DOM) manipulating, asynchronous HTTP requests and the like.

Client computing devices 1200 are preferably provided with a browser application 1210, such as the Google Chrome™, Mozilla Firefox™ or Microsoft Edge™ browser applications. The browser application 1210 requests hypertext web pages from the web server 1100 and renders the hypertext web pages on a display device for a user to view.

Client-side code is also downloadable as applications on the client computing device 1200 and/or server 1100, in order to facilitate the operation of and/or interaction with the monitoring system 2000. Such applications could, for example, be downloaded from the Apple App Store™, Google Play™, or from a dedicated service provider, or the like.

Client computing devices 1200 may communicate over the Internet 1300 with the Server 1100 or monitoring system 2000 via fixed line or wireless communication, for example, using known networks of cellular communication towers 1400. It is further envisaged that the monitoring system 2000 may communicate with the client computing devices 1200 and/or server 1100 via satellites 1600, such as low orbit satellites via a satellite communications link such as Starlink™ or similar.

### Monitoring System

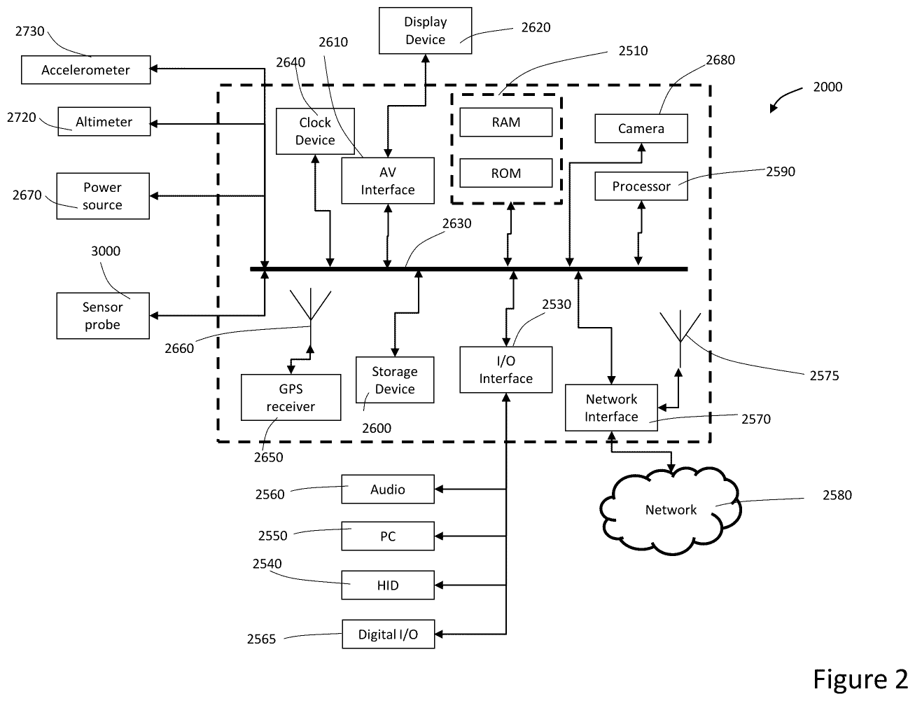

FIG. 2 shows a monitoring system 2000. The steps of the monitoring system 2000, as described in further detail below, can be implemented as computer program code instructions executable by the monitoring system 2000.

The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The monitoring system 2000 preferably comprises semiconductor memory 2510 comprising volatile memory such as random access memory (RAM) or read only memory (ROM). The memory 2510 may comprise either RAM or ROM or a combination of RAM and ROM.

The monitoring system 2000 further comprises I/O interface 2530 for communicating with one or more peripheral devices. The I/O interface 2530 may offer both serial and parallel interface connectivity. For example, the I/O interface 2530 may comprise a Small Computer System Interface (SCSI), Universal Serial Bus (USB) or similar I/O interface. The I/O interface 2530 may also communicate with one or more human input devices (HID) 2540 such as keyboards, pointing devices, joysticks and the like.

The I/O interface 2530 may also comprise a computer to computer interface, such as a Recommended Standard 232 (RS-232) interface, for interfacing the monitoring system 2000 with one or more personal computer (PC) devices 2550. The I/O interface 2530 may also comprise an audio interface 2560 for communicating audio signals to one or more audio devices (not shown), such as a speaker or a buzzer. The I/O interface 2530 may also be configured for digital input/output 2565, that is to receive digital inputs and send digital outputs.

The monitoring system 2000 also comprises a network interface 2570 for communicating with one or more computer networks 2580, such as the Internet 1300. The network 2580 may be a wired network, such as a wired Ethernet™ network or a wireless network, such as a Bluetooth™ network or IEEE 802.11 network. The network 2580 may be a local area network (LAN), such as a home or office computer network, or a wide area network (WAN), such as the Internet or private WAN. The network 2580 is preferably a cellular network, 11tilizing any suitable protocol including global system for mobile communication (GSM), Gen packet radio service (GP RS), Enhanced Data Rates for GSM Evolution (EDGE), Universal Mobile Telecommunications Service (UMTS); High-Speed Packet Access (HSP A), Code Division Multiple Access (CDMA), Evolution-Data Optimised (EV-DO, EV DO, or 1×EV-DO), or Wi-MAX. It is further envisaged that the network 2580 may operate using Internet Of Things (IoT) protocols over wide area networks. Lastly, it is envisaged that the network 2580 may be a satellite network that operates on any satellite networking protocols.

The monitoring system 2000 can also include a suitable antenna 2575 configured for wireless communication with network 2580.

The monitoring system 2000 comprises an arithmetic logic unit or processor 2590 for performing the computer program code instructions. The processor 2590 may be a reduced instruction set computer (RISC) or complex instruction set computer (CISC) processor or the like. Preferably the processor 2590 is an STM32 microprocessor.

The monitoring system 2000 further comprises a storage device 2600, such as a magnetic disk hard drive, flash drive, or a solid-state disk drive for storing data and/or software instructions.

Computer program code instructions may be loaded into the storage device 2600 from the network 2580 using network interface 2570. Alternatively, computer program code instructions may be loaded into the storage device 600 from an online resource via the network 2580 and network interface 2570.

At least the processor 2590 and the storage device 2600 with stored software instructions together comprise a controller for controlling the various components described.

During the bootstrap phase, an operating system and one or more software applications are loaded from the storage device 2600 into the memory 2510. During the fetch-decode-execute cycle, the processor 2590 fetches computer program code instructions from memory 2510, decodes the instructions into machine code, executes the instructions and stores one or more intermediate results in memory 2510.

In this manner, the instructions stored in the memory 2510, when retrieved and executed by the processor 2590, configures the computing device 500 as a special-purpose machine that may perform the functions described herein.

The monitoring system 2000 can also include an audio/video interface 2610 for conveying video signals to a display device 2620, such as a liquid crystal display (LCD), light emitting diode (LED) display, organic light emitting diode (OLED) display, cathode-ray tube (CRT) or similar display device.

The monitoring system 2000 preferably includes a communication bus subsystem 2630 for interconnecting the various devices described above. The bus subsystem 2630 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like. The monitoring system 2000 can also include a clock device 2640 configured for providing accurate time stamps for use by the processor 2590.

The monitoring system 2000 includes a geo-positioning receiver 2650 and associated antenna 2660 configured for receiving due positioning signals from geo-positioning satellites. Such a geo-positioning transceiver 2650 may receive signals from wide variety of geo-positioning system satellites, including GPS, GLONASS, Beidou, QZSS, IRNSS, NavIC and Galileo.

The monitoring system further includes a power source in the form of a battery 2670. Alternative power sources in the form of a supercapacitor or any other suitable power source may be provided. It is envisaged that power generation devices (not shown) such as solar panels and the like may be provided, in order to supplement the power being stored in the battery 2670, however this is not preferred.

The monitoring system 2000 will also be configured for connection to a sensor probe 3000 as will be described in more detail below. It may also be configured for connection to other sensors, for example, via controlled area network (CANbus), inter-integrated circuit I²C or other protocol.

Lastly, it is anticipated that the monitoring system 2000 can include a camera 2680. The camera can be used to receive images and/or video of the area surrounding the monitoring system 2000. The camera 2680 may be connected via the I/O interface 2530 or may be built into the monitoring system 2000.

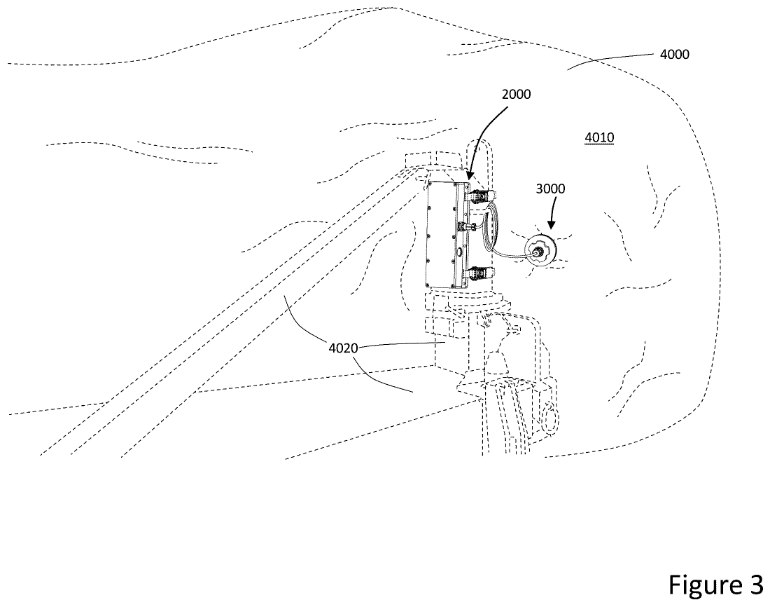

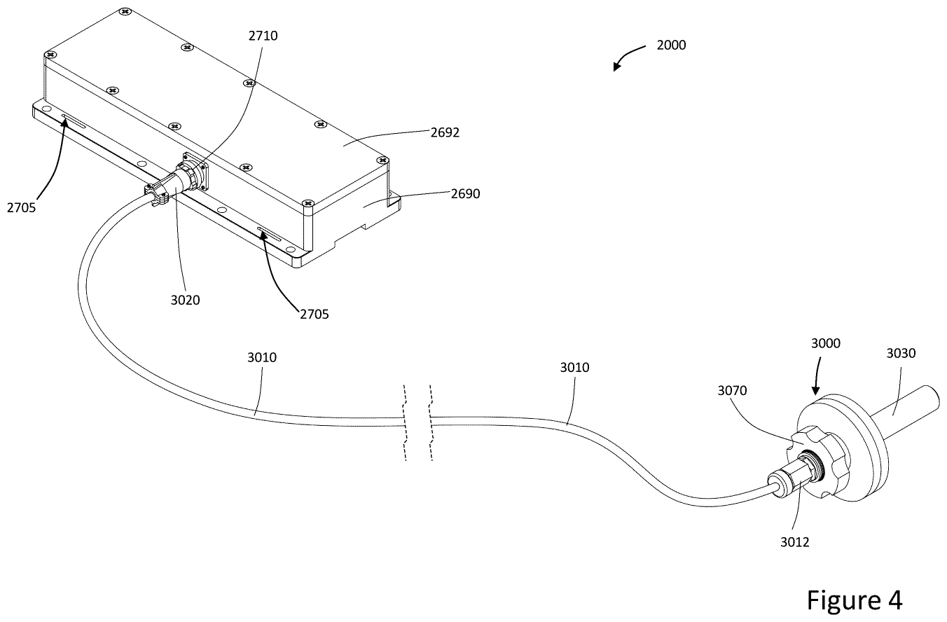

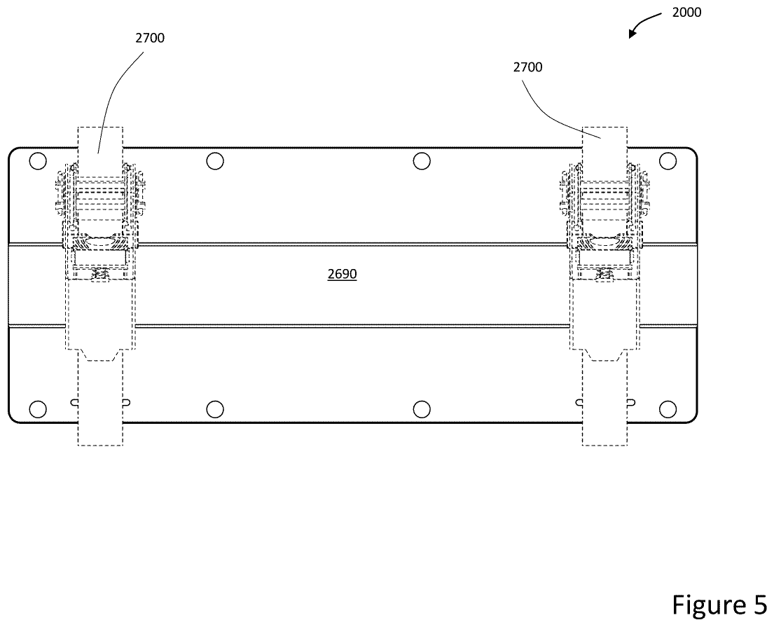

An embodiment of a monitoring system 2000 is shown in FIGS. 3-4. The monitoring system 2000 includes a housing 2690. The housing 2690 may include a lid 2692 and is preferably configured for being waterproof, preferably up to an IP 66 rating. In this regard, and an O-ring (not shown) may be provided in a groove for sealing the lid 2692 on to the housing 2690. The various electrical components described above are preferably housed within the housing. The housing 2690 preferably includes a sealed on/off switch (not shown) by which the monitoring system can be switched on and off.

The housing 2690 includes slots 2705 through which ratchet straps 2700 may be inserted. As may be seen in FIG. 3, a securing mechanism in the form of a pair of ratchet straps 2700 is used to preferably secure the housing 2690 to a support base on which the jet engine (not shown) is mounted. Alternative securing forms are also envisaged besides ratchet straps, such as bungee cords, adhesive tape, bolts or the like. In this regard, the housing 2690 is preferably also provided with holes for bolts to allow for mounting options.

Housing 2690 includes cable connector 2710 for the connection of an electrical connection cable 3010 that extends to sensor probe 3000.

Preferably housed within the housing 2690, and also connected to the controller are altimeter 2720 and accelerometer 2730.

### Sensor Probe

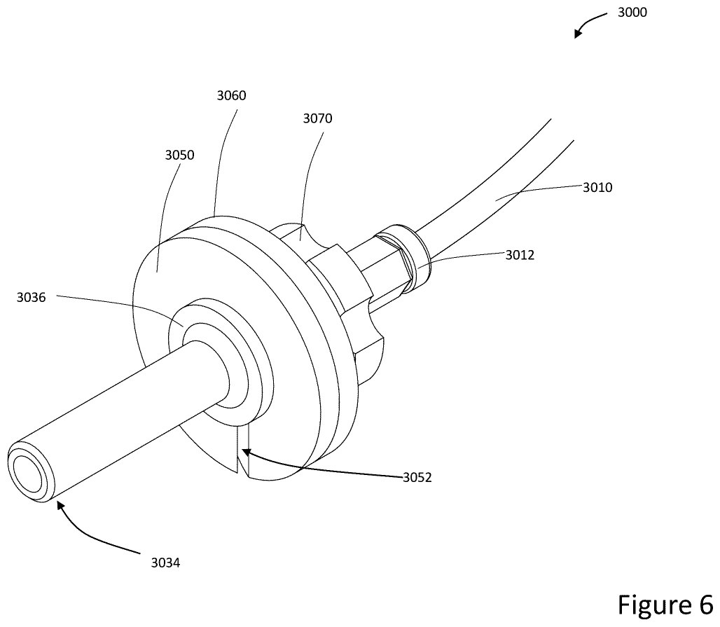

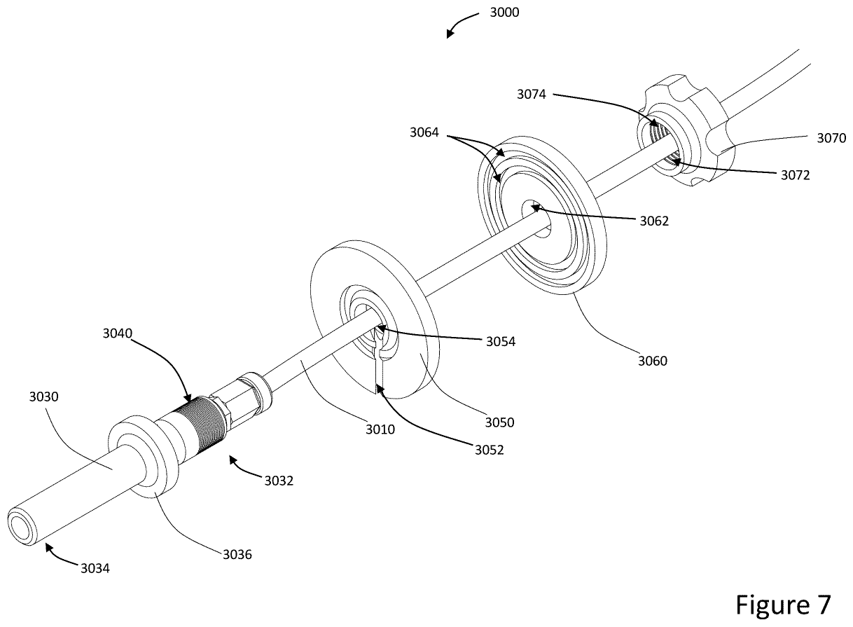

Now described with reference to FIGS. 4, and 6-13, a sensor probe 3000 is provided for being inserted into the engine enclosure 4000 in which the jet engine is preferably enclosed. The engine enclosure 4000 is preferably made of plastic sheeting such as shrink-wrapped plastic sheeting 4010. The plastic sheeting may be made of PVC, polyester or any other material that is suitable for reducing the range of temperature and humidity changes around the jet engine during transit.

The sensor probe 3000 includes a connection cable 3010 with MIL-SPEC fitting connector 3020 that is connectable to cable connector 2710 on the housing 2690. The sensor probe 3000 further includes a probe formation or probe body 3030 to which the connection cable 3010 is connected at a fitting 3012. Probe body 3030 is preferably substantially cylindrical in shape, and extends from a proximal end 3032 at which the connection cable 3010 is connected, to a distal end 3034. The probe body 3030 preferably houses a humidity sensor as well as a temperature sensor. It is envisaged that additional sensors may be housed within the sensor probe.

A thread formation 3040 is defined on an outer surface of the probe body 3030 at its proximal end 3032. The probe body 3030 further defines an abutment flange formation 3036 approximately midway along its length.

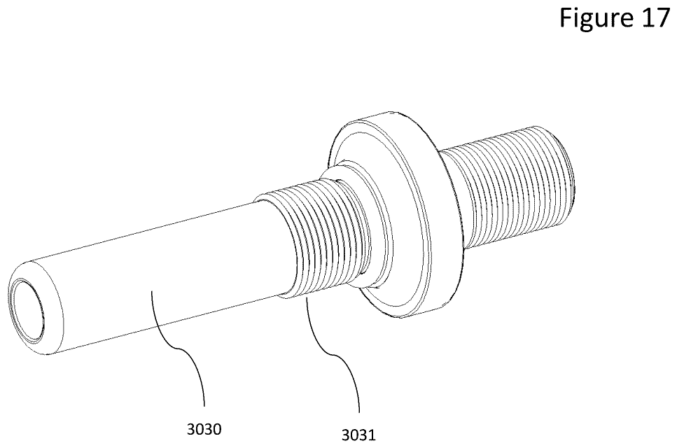

In another embodiment, as shown in FIG. 17, the probe body 3030 comprises a thread formation 3031 at its distal end so it can be threaded into vacuum ports that comprise a complimentary threaded engagement.

An inner abutment member 3050 is provided for extending inwardly of the enclosure. Inner abutment member 3050 is preferably disc shaped, and includes slot 3052 that extends radially from a central aperture 3054 to the outer periphery of the disc. The diameter of the inner aperture 3054 is preferably larger than the outer diameter of thread formation 3040. The diameter of the inner aperture 3054 is also smaller than the outer diameter of abutment flange formation 3036.

An outer abutment member 3060 is provided for extending outwardly of the enclosure, and includes a central aperture 3062. Similarly, the diameter of the inner aperture 3062 is greater than the outer diameter of thread formation 3040. Outer abutment member 3060 is also provided with a pair of slots 3064 for receiving O-rings (not shown) fitted into a major face that will be abutted against inner abutment member 3050 and plastic sheeting 4010.

Lastly, lock nut 3070 is provided. The lock nut 3070 defines a central aperture 3072 in which a thread formation 3074 is defined that is complementary to the thread formation 3040 on the outer surface of the sensor body 3030. Gripping formations 3076 are provided on an outer periphery of the lock nut 3070.

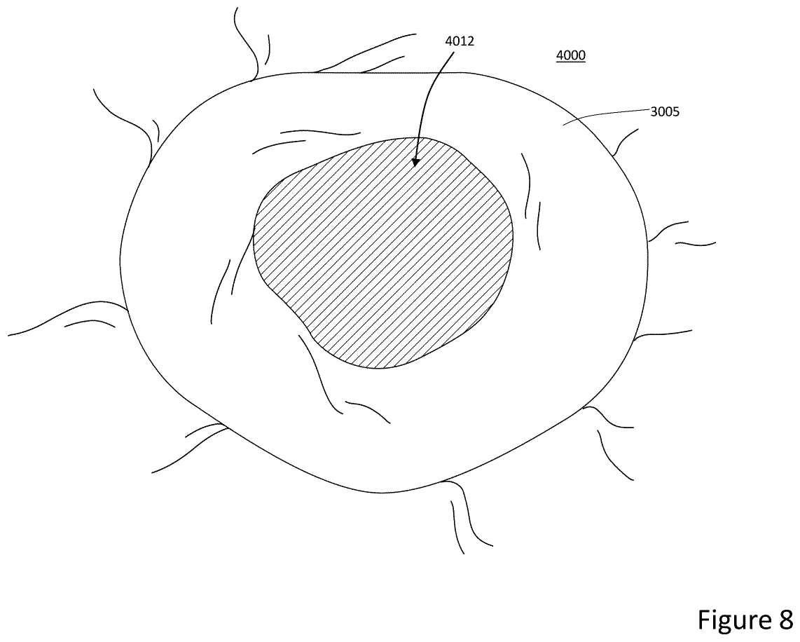

In use, it is envisaged that the sensor probe 3000 will be installed through an aperture 4012 in plastic sheeting 4010. As shown in FIG. 8, preferably a sticker 3005 will be placed on the plastic sheeting 4010 of the enclosure 4000. An aperture 4012 will then be cut in the centre of the sticker 3005. In this way, aperture 4012 will be surrounded by a tough, resilient sticker 3005. The sticker 3005 is a template which has 2 purposes. Firstly, as a guide when cutting the 50 mm hole in the plastic sheeting 4010 in the center of the sticker 3005. Secondly, as a guide to align the outer edge of the outer abutment member 3060 to ensure the assembly is centralised when tightening.

Preferably the aperture 4012 will be located behind the engine fan assembly and will be around 50 mm diameter.

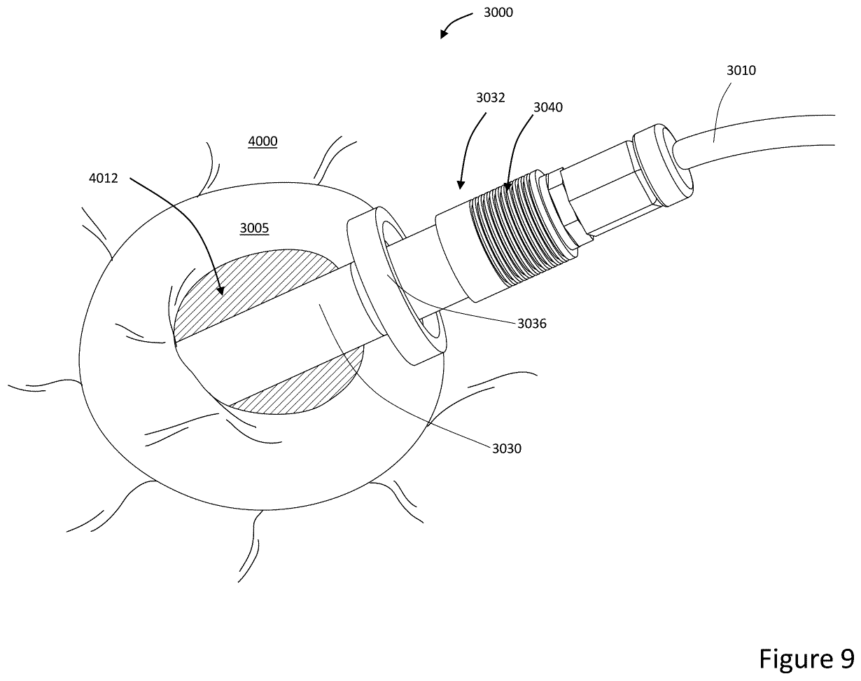

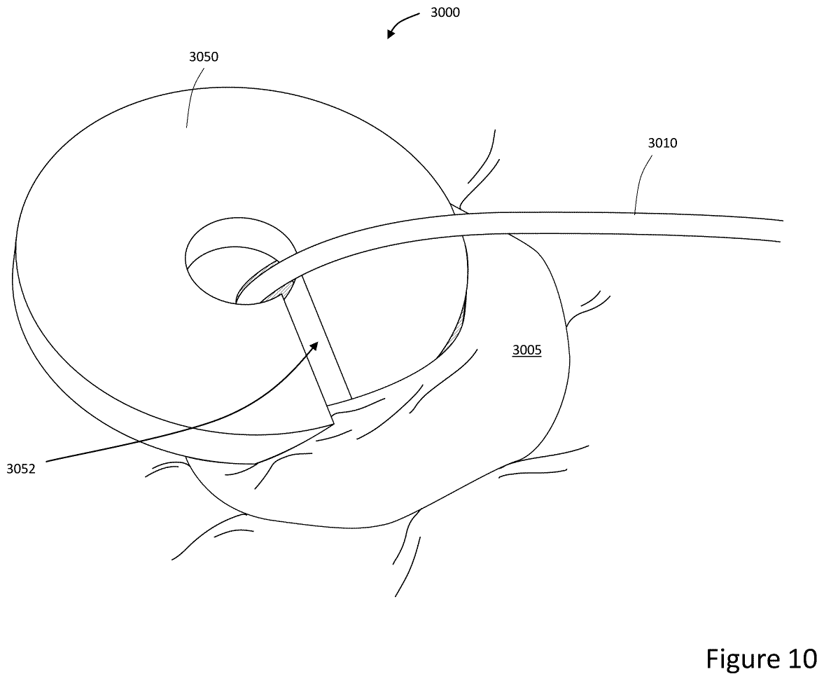

Initially, and as shown in FIG. 9, the sensor probe body 3030 will be inserted into the aperture 4012, with the distal end 3034 extending into the enclosure 4000. Then, as shown in FIG. 10, inner abutment member 3050 will be provided with the cable 3010 extending through central aperture 3054. The plastic sheeting 4010 will be fed through slot 3052 on the inner abutment member 3050, and the inner abutment member 3050 will be turned preferably clockwise until the inner abutment member is inside the enclosure 4000.

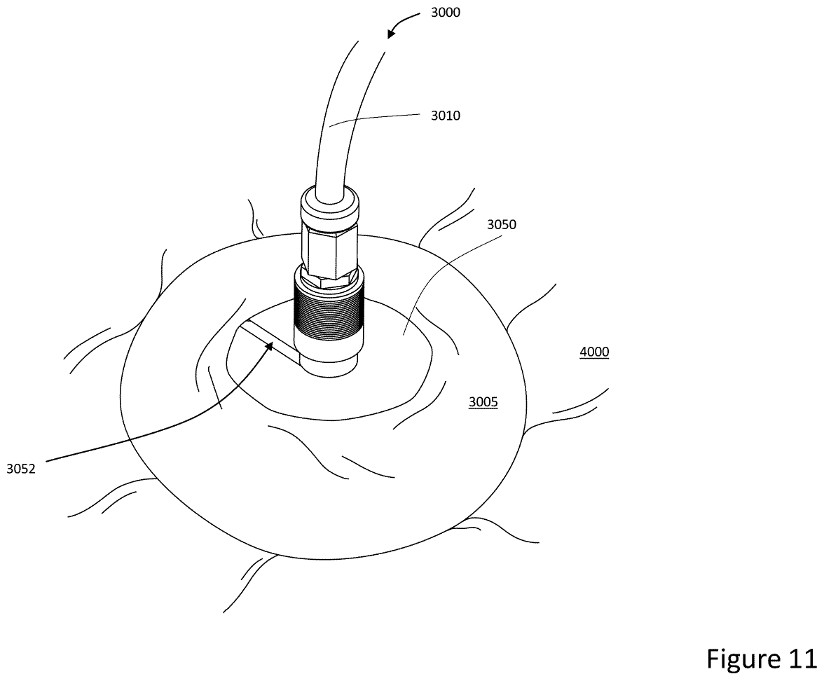

At this stage, and as illustrated in FIG. 11, cable 3010 will be pulled until the abutment flange formation 3036 abuts up against the inner abutment member 3050, proximal end 3032 extends outwardly of the enclosure 4000 and the inner abutment member 3050 is abutting against an inner surface of the enclosure 4000. Abutment flange formation 3036 prevents inner abutment member 3050 moving more distally than the location of the abutment flange formation, and prevents the inner abutment member 3050 from moving over the distal end 3034 of the probe body 3030 and being lost into the enclosure 4000.

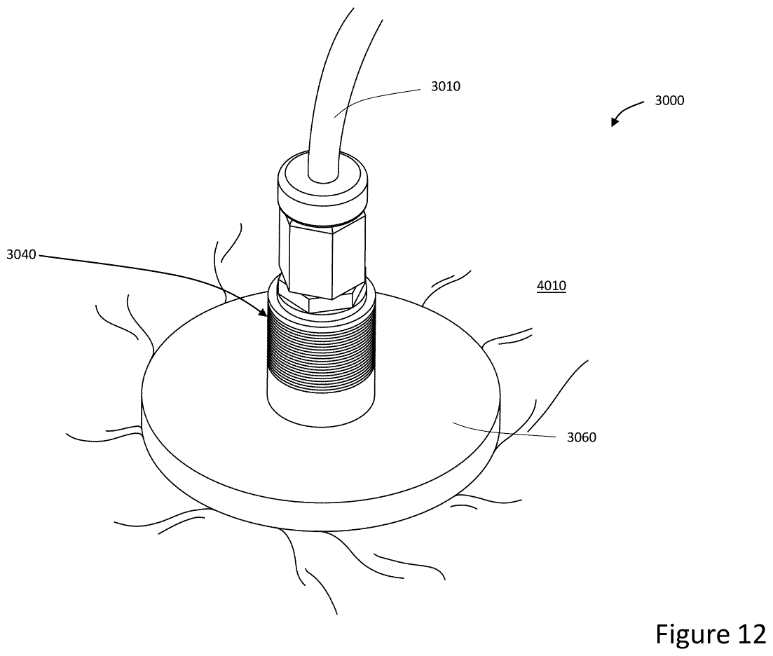

Now as illustrated in FIG. 12, outer abutment member 3060 will then be provided with cable 3010 extending through central aperture 3062. Outer abutment member 3060 will be moved from the proximal and 3032 of the probe body 3030 towards the distal end 3034 until the outer abutment member 3060 is prevented from further movement distally by the plastic sheeting 4010 supported by inner abutment member 3050. In this way, plastic sheeting 4010 is held between outer abutment member 3060 and inner abutment member 3050.

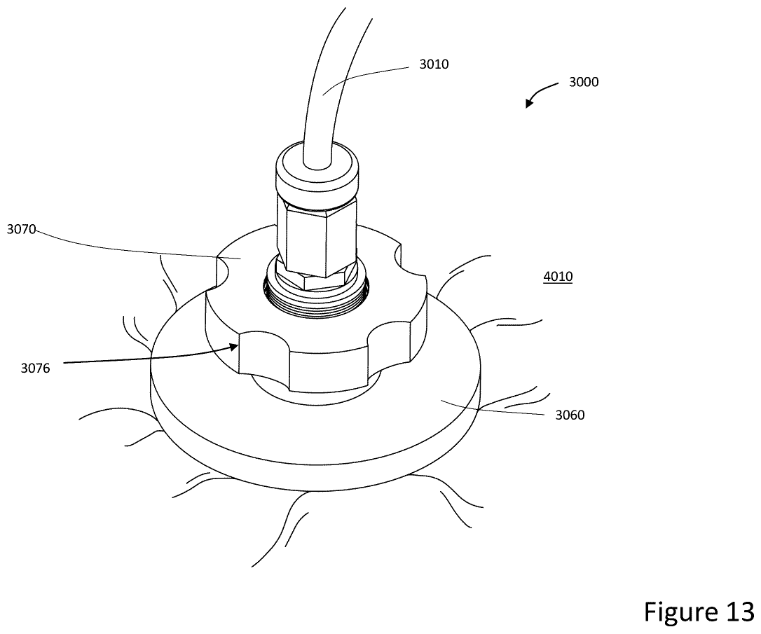

As illustrated in FIG. 13, lock nut 3070 is then provided with cable 3010 extending through central aperture 3072. Lock nut 3070 is then threaded onto thread formation 3040 and tightened to clamp the inner abutment member 3050, plastic sheeting 4010 and outer abutment member 3060 between lock nut 3070 and abutment flange formation 3036. As the lock nut 3070 is tightened, it abuts against an outer major surface of outer abutment member 3060, thereby causing outer abutment member 3060 to be firmly pushed against the plastic sheeting 4010 (again supported by inner abutment member 3050). In this way, sensor probe 3000 may be mounted in position through aperture 4012 in enclosure 4000, while preventing ingress of air moisture via aperture 4012.

### Functionality

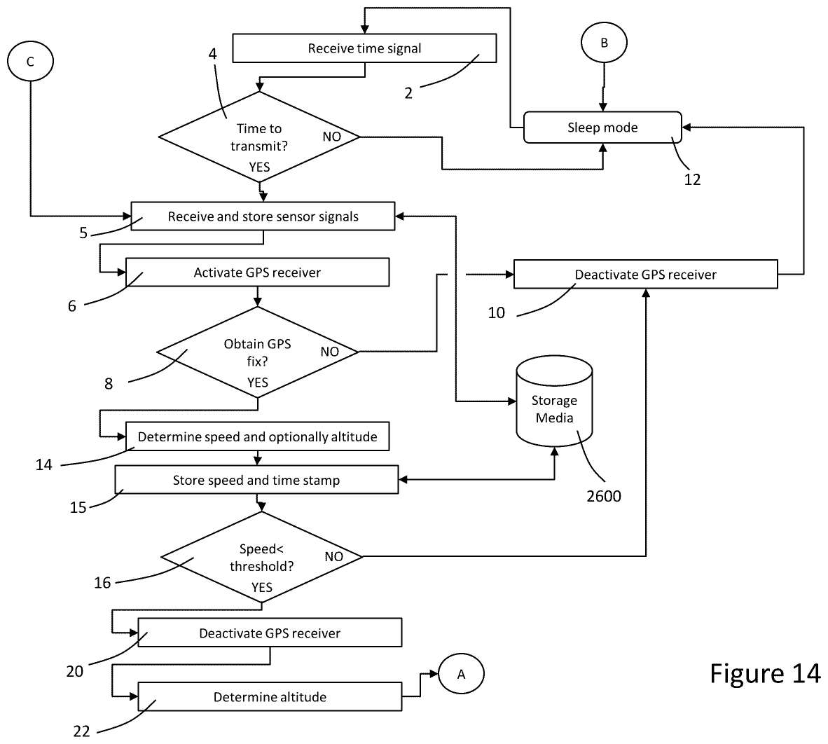

The functionality of the monitoring system described above will now be explained with reference to the flowcharts shown in FIGS. 14-16. In a discussion of the functionality below, communications between parties are preferably over a secure communication network.

Once the switch is set to “on”, it is envisaged that the monitoring system will boot up and may run through a self-test, including testing the battery status, external interface test, temperature and humidity sensor test, as well as altitude sensor test.

The monitoring system 2000 will then attempt to obtain a GPS fix and the internal clock device 2640 will be calibrated with the GPS clock signal.

The monitoring system 2000 will then enter a reduced power usage “sleep” state in which only the internal clock crystal oscillator and accelerometer remain operational. In this regard it should be noted that the accelerometer will be consistently monitored for a signal while the monitoring system 2000 is on.

In summary, the monitoring system is then used to periodically wake up from the reduced power usage sleep state, and move to an increased power usage active state to check on the status of the enclosure, including the temperature and humidity within the enclosure 4000. In addition, the location of the monitoring system 2000 will also be periodically and preferably simultaneously checked by referencing geo-positioning signals received from geo-positioning satellites. Signals received from the temperature sensor, humidity sensor and accelerometer, as well as the geo-positioning signals will be transmitted to a remote location where these details can be viewed by users, preferably over the Internet.

However, if, on waking, the monitoring system 2000 determines that the monitoring system is currently on a flight, no such transmission will take place, and instead the monitoring system will be put into a flight mode where transmissions outwardly are preferably prevented. In order to determine whether the monitoring system 2000 is on a flight, the monitoring system will determine the speed and/or altitude of the monitoring system. This process is explained in more detail below with reference to FIGS. 14-16.

Referring now to FIG. 14, when the monitoring system 2000 is in sleep mode 12, it will receive 2 a time signal from the internal clock device 2640. The monitoring system may be preprogrammed to generate transmissions at predetermined times, or at predetermined time intervals. The monitoring system 2000 will determine 4 whether it is time to generate a transmission. If it is not determined to be the correct time, then the monitoring system will return to sleep mode. If it is time to generate a transmission, then the sensor signals from the sensor probe 3000 will be received 5, and GPS receiver will be activated 6. Monitoring system 2000 will then attempt to receive geo-positioning signals from geo-positioning satellites in order to obtain 8 a fix on the current location of the monitoring system.

The speed of the monitoring system 2000 (and hence the jet engine) is then determined 14 from the geo-positioning signals. In this regard, the velocity of the monitoring system 2000 may also be determined.

The determined speed is then preferably stored 15 on digital storage media 2600, preferably with a time stamp.

The monitoring system 2000 then determine 16 whether the speed is above a predetermined threshold. The predetermined threshold may, for example, be slightly higher than the takeoff speed for an aircraft that is used to transport jet engines.

If the speed is determined 16 not to be lower than the threshold, then the determined speed is stored 18, preferably together with a time stamp. The GPS receiver is then deactivated 10, and the monitoring system 2000 will return to a reduced power usage sleep mode 12.

If the speed is determined 16 to be below the threshold, then the GPS receiver will be deactivated 20 to save power. At this stage, the monitoring system 2000 will determine 22 the altitude of the monitoring system from the altimeter.

It is envisaged that in an alternative embodiment the altitude may be determined from the received geo-positioning signals from the geo-positioning satellites at the same time that the speed is determined.

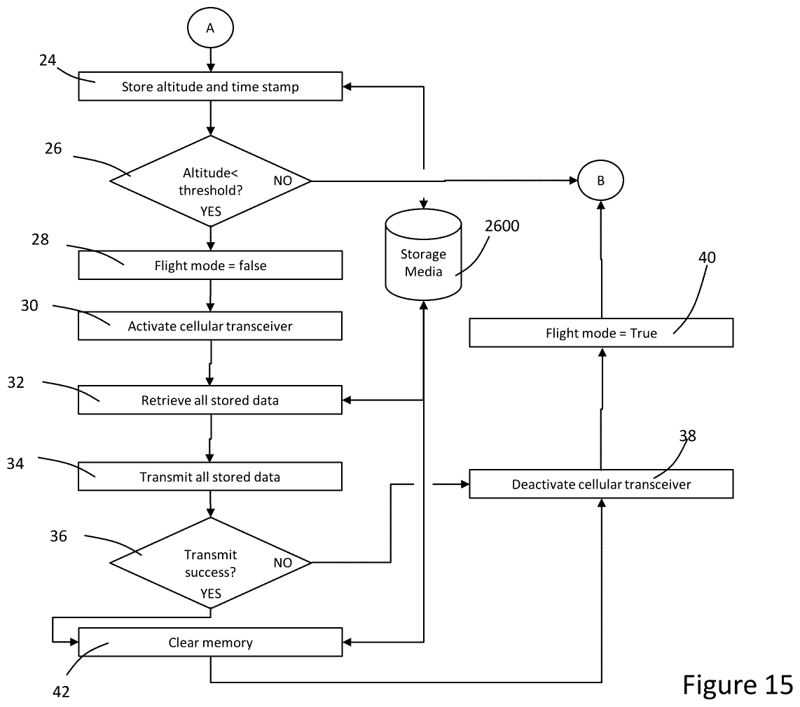

Referring now to FIG. 15 and following on from reference letter A, the monitoring system then stores 24 the determined altitude on storage media 2600. The monitoring system 2000 then determines 26 whether the altitude is below a predetermined threshold. If the altitude is not below the predetermined threshold, then the monitoring system will return, via reference letter B to sleep mode. The altitude threshold may, for example, be about 50 m, 100 m or 200 m higher than the altitude of a typical freight airport or of a freight airport within a particularly operational route.

If the altitude is below the predetermined threshold, then the monitoring system will configure 28 in a mode (i.e. not flight mode) where transmissions outwardly are possible. The cellular transceiver will then be activated 30. The stored sensor signals, determined speed, determined altitude, as well as any stored accelerometer signals will then be retrieved 32 from the storage media 2600 and transmitted 34. The monitoring system 2000 will then determine 36 whether the transmission has been a success. If the transmission has not been a success, then the monitoring system 2000 will deactivate 38 the cellular transceiver and configure 40 the monitoring system in a flight mode where external wireless transmissions are not possible.

If the transmission has been a success, then the monitoring system will clear the data from the storage media 2600 in order to save space on the storage media, and will then deactivate 38 the cellular transceiver in order to save power. After this, the monitoring system will reconfigure 40 into a flight mode where external wireless transmissions are not possible, and return to sleep mode 12. In this way, external wireless transmissions will not be transmitted while the monitoring system 2000 and jet engine are on a flight.

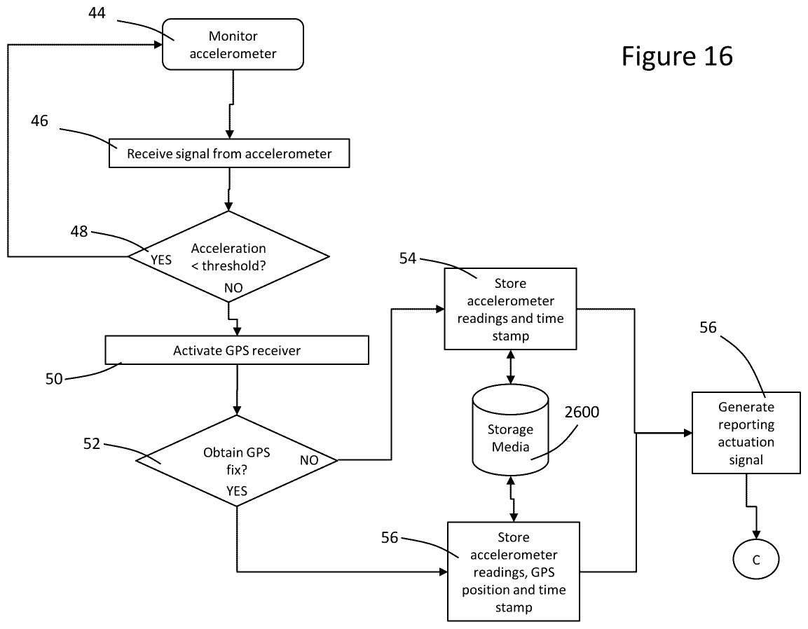

It is further envisaged that at any stage during the above process, and with reference to FIG. 16, the monitoring system 2000 will further monitor 44 the accelerometer for signals coming from the accelerometer. On receiving 46 signals from the accelerometer, the monitoring system will determine 48 whether the measured acceleration of the accelerometer is below a predetermined threshold. If it is below the predetermined threshold then the monitoring system will continue monitoring 44 the accelerometer. If the measured acceleration of the accelerometer is not below the predetermined threshold, then this indicates a high acceleration event, and preferably the GPS receiver will be activated 50. The monitoring system 2000 will then determine 52 whether a GPS fix is able to be obtained. If a GPS fix is not able to be obtained, then the monitoring system 2000 will store 54 the accelerometer reading on digital storage media 2600, preferably with a time stamp. If a GPS fix is able to be obtained, then the monitoring system 2000 will store 56 the accelerometer reading and the GPS position, preferably with a time stamp on digital storage media 2600. The stored accelerometer reading, timestamp and optionally GPS position will preferably be retrieved 32, together with the altitude, speed, current GPS location and their associated timestamps when possible, and preferably when the monitoring system is not in flight.

It is further envisaged that the duration that the acceleration is above a predetermined threshold may be determined, and if the duration of the acceleration above a predetermined threshold is longer than a predetermined duration threshold, then the duration of the high acceleration event may also be stored. In addition it is envisaged that the peak acceleration, the average acceleration and the duration of high acceleration above a predetermined threshold may be stored.

It is further envisaged that if a high acceleration event above a predetermined acceleration threshold is determined, and/or if the duration of such a high acceleration event exceeds a predetermined duration, this may trigger the generation 56 of a reporting actuation signal that will attempt to transmit data immediately, regardless of whether or not the time is a predetermined reporting time.

In this way, regular periodic measurements of the location, humidity, temperature, current location and speed, together with irregular accelerations as well as the time and location that they were received, can be transmitted to a remote server, where they can be made available to users. This can be done at no risk to an aircraft that may be transporting the jet engine and monitoring systems.

It will be appreciated by those skilled in the art that the monitoring of a value to establish whether it is below or equal to a predetermined threshold could also be accomplished by monitoring whether the value is above or equal to a predetermined threshold.

### Interpretation

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The terminology used herein is for the purpose of describing particular embodiments only and is not intended to be limiting of the invention. As used herein, the singular articles “a”, “an” and “the” are intended to include the plural forms as well, unless the context clearly indicates otherwise and thus are used herein to refer to one or to more than one (i.e. to “at least one”) of the grammatical object of the article. By way of example, the phrase “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

The term “real-time” for example “displaying real-time data,” refers to the display of the data without intentional delay, given the processing limitations of the system and the time required to accurately measure the data.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

### In Accordance With

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

It will be appreciated that the methods/apparatus/devices/systems described/illustrated above at least substantially provide a monitoring system.

The monitoring system described herein, and/or shown in the drawings, are presented by way of example only and are not limiting as to the scope of the invention. Unless otherwise specifically stated, individual aspects and components of the monitoring system may be modified, or may have been substituted therefore known equivalents, or as yet unknown substitutes such as may be developed in the future or such as may be found to be acceptable substitutes in the future. The monitoring system may also be modified for a variety of applications while remaining within the scope and spirit of the claimed invention, since the range of potential applications is great, and since it is intended that the present invention be adaptable to many such variations.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Chronological Order

For the purpose of this specification, where method steps are described in sequence, the sequence does not necessarily mean that the steps are to be carried out in chronological order in that sequence, unless there is no other logical manner of interpreting the sequence.

### Markush Groups

In addition, where features or aspects of the invention are described in terms of Markush groups, those skilled in the art will recognize that the invention is also thereby described in terms of any individual member or subgroup of members of the Markush group.

### INDUSTRIAL APPLICABILITY

It is apparent from the above, that the arrangements described are applicable to the aircraft maintenance industries.

What is claimed is:

1. A monitoring system for monitoring an off-wing jet engine in transit, the monitoring system comprising:
a. at least one wireless transceiver;
b. at least one selected from
i. a geo-positioning receiver configured for receiving geo-positioning signals from geo-positioning satellites, and
ii. an altimeter;
c. a controller, the controller comprising:
i. a processor operatively configured for executing instructions;
ii. digital storage media operatively connected to the processor and configured for storing data and instructions, the instructions being configured to direct the processor to:
1. receive at least one selected from
a. geo-positioning signals from a geo-positioning satellite,
b. pressure signals from an altimeter;
2. determine at least one selected from
a. the speed of the monitoring system, and
b. the altitude of the monitoring system;
3. determine whether at least one selected from
a. the speed of the monitoring system exceeds a predetermined threshold; and
b. the altitude of the monitoring system exceeds a predetermined threshold;
4. transmit a status signal if one or more selected from the determined speed and the determined altitude of the monitoring system is below the predetermined threshold;
d. a sensor probe, the sensor probe being operatively connected to the controller; and
e. a flexible sheeting for enclosing the off-wing jet engine, the flexible sheeting comprising an aperture,
wherein the sensor probe is configured to be inserted into the aperture, an inner abutment formation of the sensor probe is configured to be in abutment with an inner surface of the flexible sheeting and an outer abutment formation of the sensor probe is configured to be in abutment with an outer surface of the flexible sheeting such that in use, a locking arrangement presses a portion of the flexible sheeting between the inner abutment formation and outer abutment formation, thereby holding the sensor probe in place.

2. The monitoring system as claimed in claim 1, wherein the instructions are configured to direct the processor to:
a. in the event that at least one selected from the determined speed and the determined altitude of the monitoring system is above the respective predetermined threshold, prevent the transmission of signals from the at least one or more wireless transceivers.

3. The monitoring system as claimed in claim 1, wherein the instructions are configured to direct the processor to:
a. in the event that at least one from the determined speed and the determined altitude of the monitoring system is above the respective predetermined threshold, store at least one selected from the determined speed and the determined altitude, together with a time stamp.

4. The monitoring system as claimed in claim 1, wherein the instructions are configured to direct the processor to:
a. in the event that at least one selected from the determined speed and the determined altitude of the monitoring system is above the respective predetermined threshold, store one or more selected from the determined speed and the determined altitude, together with the location of the monitoring system and a time stamp.

5. The monitoring system as claimed in claim 1, wherein the status signal includes the speed of the monitoring system.

6. The monitoring system as claimed in claim 1, wherein the status signal includes unique identifier for the monitoring system.

7. The monitoring system as claimed in claim 1, wherein the sensor probe includes at least one sensor.

8. The monitoring system as claimed in claim 7, wherein the at least one sensor includes at least one selected from:
a. a temperature sensor;
b. a humidity sensor; or
c. a third sensor.

9. The monitoring system as claimed in claim 7, wherein the instructions are configured to direct the processor to:
a. receive sensor signals from the at least one sensor.

10. The monitoring system as claimed in claim 9, wherein the instructions are configured to direct the processor to:
a. receive sensor signals from the at least one sensor at regular time intervals.

11. The monitoring system as claimed in claim 1, wherein the instructions are configured to direct the processor to:
a. store the received geo-positioning signals as monitoring events, together with a time stamp.

12. The monitoring system as claimed in claim 10, wherein the instructions are configured to direct the processor to:
a. store the received sensor signals as monitoring events, together with a time stamp.

13. The monitoring system as claimed in claim 1, wherein the status signal includes the sensor signals.

14. The monitoring system as claimed in claim 12, wherein the instructions are configured to direct the processor to:
a. in the event that at least one selected from the determined speed and the determined altitude is above a predetermined threshold, store the received sensor signals as monitoring events, together with a time stamp;
b. monitor the determined speed and transmitting the stored monitoring events once the determined speed drops below the predetermined threshold.

15. The monitoring system as claimed in claim 1, wherein the controller is housed within a control box.

16. The monitoring system as claimed in claim 15, wherein the control box includes a mounting arrangement configured for mounting the control box to a support base for the off-wing jet engine.

17. The monitoring system as claimed in claim 16, wherein the mounting arrangement includes one or more ratchet straps.

18. The monitoring system as claimed in claim 17, wherein the mounting arrangement includes a pair of ratchet straps attached to opposed ends of the control box.

19. The monitoring system as claimed in claim 1 further comprising an accelerometer, wherein the instructions are configured to direct the processor to:
a. receive an acceleration signal from the accelerometer.

20. The monitoring system as claimed in claim 19, wherein the instructions are configured to direct the processor to:
a. determine whether the acceleration signal exceeds a predetermined threshold.

21. The monitoring system as claimed in claim 20, wherein the instructions are configured to direct the processor to:
a. in the event of the acceleration signal exceeding a predetermined threshold, retrieve the geo-positioning signal from the geo-positioning sensor.

22. The monitoring system as claimed in claim 21, wherein the instructions are configured to direct the processor to:
a. store the acceleration signal together with a timestamp and/or geo-positioning signal.

23. The monitoring system as claimed in claim 15, wherein the control box is configured to be securely attached to a base support for the off-wing jet engine.
